(19) United States
(12) Patent Application Publication
(10) Pub. No.: US 2013/0321149 A1
(43) Pub. Date: Dec. 5, 2013

(54) SYSTEM AND METHOD FOR FOREST FIRE CONTROL

(71) Applicants: Eran Ben-Shmuel, Savyon (IL); Alexander Bilchinsky, Yahud (IL)

(72) Inventors: Eran Ben-Shmuel, Savyon (IL); Alexander Bilchinsky, Yahud (IL)

(73) Assignee: RAOUL WALLENBERG 14A, TEL-AVIV (IL)

(21) Appl. No.: 13/984,938

(22) PCT Filed: Feb. 9, 2012
(86) PCT No.: PCT/IL12/00072

§ 371 Date: Aug. 12, 2013

Related U.S. Application Data
(60) Provisional application No. 61/441,303, filed on Feb. 10, 2011.

(51) Int. Cl. G08B 17/00

(52) U.S. Cl. CPC G08B 17/005
USPC 340/539.26

(57) ABSTRACT

A system for forest fire control comprising a plurality of forest fire control nodes. Each node is comprised of one or move detection means of an environmental condition. Each node is also comprised of at least one communication transceiver for sending and receiving data indicative of a sensed environmental condition, and of at least one hanging unit configured for hanging the node on a tree.

### FIELD OF THE INVENTION

This invention relates to analysis and management of a disaster events. More specifically, it relates to analysis and management of fire in a forest.

### BACKGROUND OF THE INVENTION

Forest fires have ever challenged humanity and many efforts have been invested in this field. For example, U.S. Pat. No. 5,734,335 (“Forest surveillance and monitoring system for the early detection and reporting of forest fires”, Brogi et al., published on 31 Mar. 1998) discloses a system comprising a number of remote detectors placed within the forest area and telemetrically linked to a central processing system. Each remote detector comprises an infrared sensor and video camera mounted on a remotely controllable moving platform. The remote detector also contains a weather sensor for collecting critical weather data at the remote site. Located at each remote site is a remote processor which controls all data collection, the remote processor feeing in communication with the central site via a remote communication subsystem and central communication system which are linked via radio. The central control site receives weather data and alarm information, as well as video images from the remote detector site via the communication system. The central site contains video monitoring equipment for visual inspection of the area under surveillance as well as a central processor for overall system control. The central processor receives data from the multiple remote detectors and is capable of displaying alarms on digitized topographic maps of the forest under surveillance, as well as producing a forecast of the anticipated growth pattern of the fire front based upon the received data and information stored in a historical data base.

U.S. 2007/0056753 (“System for the control and extinction of forest fires”, Moling and Antonio, published on 15 Mar. 2007) discloses a system, for the control of forest fires and for extinction thereof, which includes means for detecting the fire, water-supply means: and water-distribution means, characterized in that said water-distribution means include a fixed installation in the terrain and in that the system includes real-time control means that pick up the signal from the detecting means and act on the water-supply means to the installation. The fire detecting means are based on infrared cameras mounted on control towers.

The article “Multicast Algorithms for Multi-Channel Wireless Mesh Networks” by Zeng et al. published in Network Protocols, 2007. ICNP 2007, IEEE International Conference on; October 2007 explains that multicast is a technology providing efficient data communication among a set of nodes for wireless multi-hop networks. In sensor networks and IV,IANETs, multicast algorithms are designed to be energy efficient and to achieve optimal route discovery among mobile nodes, respectively. However, in wireless mesh networks, which are required to provide high quality service to end users as the “last-mile” of the Internet, throughput maximization conflicting with scarce bandwidth has the paramount priority. The article proposes a Level Channel Assignment (LCA) algorithm and a Multi-Channel Multicast (MCM) algorithm to optimize throughput for multi-channel and multiinterface mesh networks. The algorithms first build a multicast structure by minimizing the number of relay nodes and hop count distances between the source and destinations, and use dedicated channel assignment strategies to improve the network capacity by reducing interference. The article also illustrates that the use of partially overlapping channels can further improve the throughput. Simulations show that the algorithms greatly outperform the single-channel multicast algorithm. MCM achieves better throughput and shorter delay while LCA can be realized in distributed manner.

### SUMMARY OF THE INVENTION

In accordance with one aspect the invention provides a system for forest fire control comprising a plurality of forest fire control nodes, each node comprising;
one or more detection means of an environmental condition;
at least one communication transceiver for sending and receiving data indicative of a sensed environmental condition; and
at least one hanging unit configured for hanging the node on a tree.

A certain embodiment of the system comprises a central unit configured to:
receive data indicative of a sensed environmental condition from at least two of the plurality of forest fire control nodes;
analyze said data to determine a forest fire status;
provide output relating to the forest fire status.

In accordance with one embodiment the system comprising
a central unit configured to receive data indicative of a sensed environmental condition over a period of time during a forest fire from at least one of the plurality of forest fire control nodes; and
a database for storing said received data; and
a processor configured to analyze said receive data to produce a prediction of future fire behavior.

Still further there is an embodiment in which the processor is configured to provide a response strategy to a forest lire based on the prediction.

In an additional embodiment a resource tracker for providing information on resource availability and wherein the processor is configured to provide the response strategy to a forest fire based on resource availability.

According to an additional embodiment of the system the processor is configured to provide a response strategy to a forest fire using an optimization algorithm.

In another embodiment of the system the processor is configured to provide a response strategy to a forest fire using a time-aligned backtracking algorithm.

Still further in a certain embodiment of the system the processor is configured to provide a response strategy to a forest fire using an algorithm designed to minimize the area expected to be covered by the fire within a predetermined period of time.

In yet another embodiment the system comprising a database containing data indicative of high priority areas within the forest area, and wherein the processor is configured to provide a response strategy to a forest fire using an algorithm designed to minimize damage to high priority areas.

In still another embodiment of the system the processor is configured to provide a response strategy to a forest fire using an algorithm designed to minimize costs of operation.

In a certain embodiment of the system the processor is configured to provide a response strategy to a forest fire using an algorithm designed to minimize hazard to firefighters.

One embodiment of the system is provided, wherein the processor is configured to provide a response strategy to a forest fire using an algorithm designed to strike a balance between at least two of:
minimizing the area expected to be covered by the fire within a predetermined period of time;
minimizing damage to high priority areas;
minimizing costs of operation; and
minimizing hazard to firefighters.

Wherein in still other embodiments of the system the nodes have a dormant state and an active state and are configured to switch from a dormant state to an active state at preset timing.

Yet another embodiment of the system comprising stationary nodes and mobile nodes, wherein the mobile nodes and stationary nodes are configured to communicate between them.

A certain aspect of the invention provides a forest fire control node, comprising:
at least one sensor of an environmental condition;
at least one communication transceiver for sending and receiving data indicative of a sensed environmental condition; and
at least one hanging unit configured for hanging the node on a tree.

According to another embodiment the forest fire control node comprising a kinetic charging mechanism.

According to certain embodiments the forest fire control node comprising a processor configured to
receive from the sensor local data indicative of a local environmental condition;
receive from the communication transceiver remote data indicative of a remote sensed environmental condition sensed by at least one remote fire control node;
analyze said local data and remote data; and
issue a response based on said analysis.

Wherein according to one embodiment of the forest fire control node the response comprises providing an instruction to the at least one remote fire control node to regulate a sensing condition of the remote fire control node.

According to an aspect of the invention there is provided a method for forest fire control comprising:
deploying a plurality of stationary forest fire control nodes over a forest area, each node comprising;
at least one sensor of an environmental condition;
at least one communication transceiver for sending and receiving data indicative of a sensed environmental condition; and
at least one hanging unit configured for hanging the node on a tree.

Wherein according to another embodiment the plurality of forest fire control nodes are deployed such that each forest fire control node is within communication distance from at least one other forest fire control node.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is a schematic presentation of a deployed system in accordance with embodiments of the invention in a forest;

FIG. 2 is an image illustrating coverage area of a system in accordance with embodiments of the invention, such as the system of FIG. 1;

FIG. 3 is a block diagram representing a forest fire control node in accordance with certain embodiments of the invention;

FIG. 4 schematically presents an example of a hanging mechanism, according to embodiments of the invention;

FIG. 5 is a schematic illustration of a hanging unit, in accordance with certain embodiments of the invention;

FIG. 6 illustrated aerial mass deployment of nodes, in accordance with one embodiment of the invention;

FIG. 7 schematically illustrates the stages of aerial-deploying a node device according to one embodiment of the invention;

FIG. 8A, FIG. 8B and FIG. 8C schematically illustrate hanging mechanisms according to embodiments of the invention;

FIG. 9 is a flowchart illustrating the main operations performed by a controlling processor, according to certain embodiments of the invention; and

FIG. 10 is a flowchart demonstrating in detail the operations performed by a controlling processor while developing firefighting strategy, according to certain embodiments of the invention.

### DETAILED DESCRIPTION

This application claims priority from U.S. Provisional Patent Application Ser. No. 61/441,303 filed on Feb. 10, 2011, the disclosure of which is incorporated herein by reference for air purposes.

In the following description components that are common to more than one figure will be referenced by the same reference numerals.

In addition, unless specifically noted, embodiments described or referenced in the present description can be additional and/or alternative to any other embodiment described or referenced therein.

Hereinafter the term “forest” comprises an outdoor environment including trees, such as an orchard, a garden, a park, woodland, a plantation, etc.

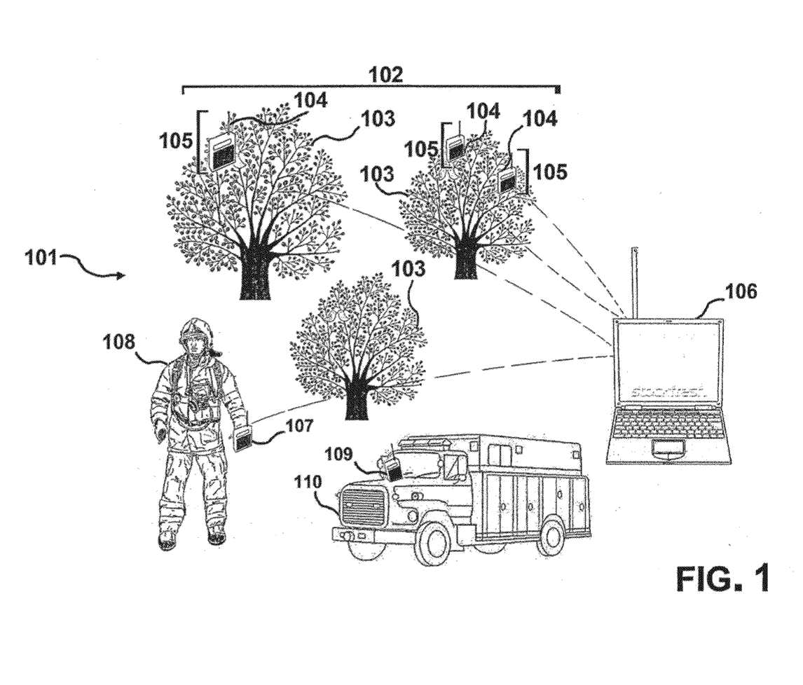

FIG. 1 is a schematic presentation of a deployed system 101 in accordance with embodiments of the invention deployed in a forest 102. In the figure, three trees f 103 represent the forest 102. Hanging units 104, being part of the system 101, are hanging on branches of some of the trees. The hanging units are coupled to one or more detection means (the detection means are not illustrated in the figure) for detecting one or more environmental conditions, while a hanging unit 104 together with the one or more detection means constitute a “forest fire control node” 105, shortly referred to as a “control node” or simply as a “node”. Many nodes according to the invention comprise a communication transceiver (shortly referred to as a “transceiver”), thereby these nodes are wirelessly coupled to a controlling processor 106 comprising a transceiver as well.

The nodes hanging on branches are stationary, i.e. throughout their lives they would normally stay on the same branch, on the same tree (unless moved for a special reason such as maintenance or if the tree is fallen, etc.). In addition to stationary nodes, a controlling processor 106 may be coupled also to mobile nodes. In FIG. 1 two different examples for mobile nodes are illustrated; a handheld node 107, carried on the wrist of a fire fighter 108, and a fixed node 109, installed in a fire engine 110. It should be appreciated though that additional or alternative mobile nodes may exist, such as floating-nodes that are configured to float on a river flowing in or near the forest and others.

Hereinafter, the terms “a node” and “nodes” refer to any kind of nodes, including stationary and mobile nodes.

According to certain embodiments nodes may interoperate: they may communicate therebetween in order to exchange information and/or in order to convey operating instructions from one note to another node or nodes. In addition to communication, according to certain embodiments, nodes may interoperate, e.g., perform together a certain measurement, in order to detect or follow a certain condition or situation. According to one non-limiting example, in order to save energy a node may enter a dormant state, while periodically and/or upon obtaining a predetermined signal communicated, conveyed from a neighboring node, the dormant node may switch to an active state. It may then return to a dormant state after a predetermined period or after performing a specific task or when receiving a predetermined signal, or when detecting a predetermined environmental condition, etc. According to another non-limiting example, one node may radiate an ultraviolate (UV) radiation, having a predetermined intensity. Knowing that smoke, for example, tends to lower UV intensity by a certain degree, upon detecting the UV radiation, a neighboring node may compare the detected radiation's intensity to the predetermined or to a calibrated value, in order to conclude and acquire information relating to the environment. This way the neighboring node may raise a suspicion that there is smoke in the air, and hence possibly also fire.

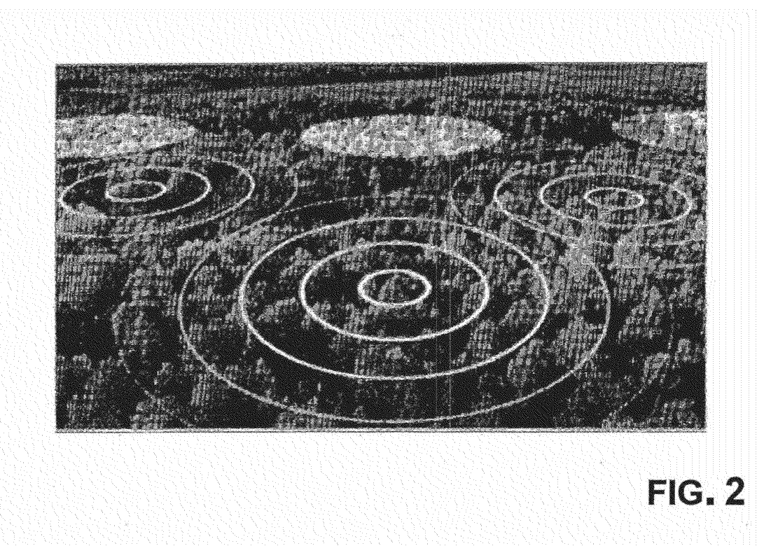

Hence, interoperability may be viewed as distributed processing. Continuing with this view, the system 101, with its spanned nodes, may be viewed as a Dynamic Distributed Wireless Network (DDWN) of nodes, configured for defecting and measuring, different characteristics (e.g. position and/or speed of the node, smoke detection and intensity measurement, wind measurements such as air-speed and direction, temperature etc.), for reporting the measurements and other information to the controlling processor and for passing messages. The nature of messaging is attended to below, further to introducing FIG. 2.

Understanding that according to the invention nodes may interoperate, it should be appreciated that each node has a radius therearound, while in order to interoperate interoperable nodes should be placed within this radius. Different forms of interoperability may allow different maximal distances between interoperating nodes. For example, the maximal distance allowed between two nodes interoperating a UV measurement may be different from the maximal distance allowed between two nodes that need only to communicate. Hence, as two nodes become closer to each other, more or different interoperability functionalities therebetween are enabled. Therefore, by deploying a plurality of nodes in a forest while the distances between, the nodes are satisfactorily small, therefore allowing required interoperability, it is possible to cover the forest area under the coverage area of system 191. Accordingly, FIG. 2 is an image illustrating coverage area of a system in accordance with embodiments of the invention, such as system 101 of FIG. 1.

Looking at FIG. 2, it can be appreciated that nodes may be connected in a two or even three-dimensional daisy-chain, for passing messages. The messages can possibly be communication messages, that is, data packets including information such as nose identification, code, positioning information, detected information, graphical information etc. Additionally or alternatively to transmission of communication messages, other forms of messaging may exist if may be considered, for example, that interoperability may also form part of messaging.

According to certain embodiments of the invention the system 101 includes transmission nodes constituting “base stations”, optionally hanging on branches in addition to the forest fire control nodes. The transmission nodes include, each, a communications transceiver that receives data communicated from neighboring nodes and transmits them to the controlling processor. While communicating information from a node to the controlling processor, data packets may be transferred from one node to another and so on, until the information reaches the controlling processor or a transmission node. According to certain embodiments, the transmission nodes have stronger communication transceivers compared to the other nodes, hence they may transmit communicated messaged to longer distances compared to the other nodes. According to certain embodiments, transmission nodes interconnected via a daisy chain, constituting a higher level communication network, while the information packets may be transferred from the one transmission node to another and so on until the information reaches a higher level transmission node or the controlling processor.

Upon communicating an information packet, the transfer thereof from one node to another node, including to a transmission node, constitutes a “hop”. It may be appreciated that after one or more hops the packet is expected to reach a transmission node, from where it will be transferred directly or through additional transmission nodes to a control processor, or it may reach the control processor itself. It should also be appreciated that a node may transfer the information packet to more than one node at once, in which case, splitting, branching out the communication rout to more than one rout, e.g., for increasing reliability. According to the invention, the list of nodes transferring an information packet from its original source node to the control processor, i.e., to its destination, is dynamically set by an algorithm such as the algorithm presented by Zeng et al. (“Multicast Algorithms for Multi-Channel Wireless Mesh Networks”) mentioned in the background of the invention. A processor executing the algorithm may run in controllers comprising the node, in controllers comprising the transmission nodes, and/or in the control processor. In accordance with certain embodiments, the algorithm may allow a node to block an information packet instead of forwarding it further to other nodes and/or to transmission nodes. Similarly, these or other embodiments may allow a transmission node to block an information packet instead of forwarding it further to the control processor.

According to some of the embodiments, the path for transmitting an information packet to the control processor may change wherein the conditions change. For example, when a mobile node changes its position, upon change of the node's characteristics (e.g., battery condition), environmental changes such as weather, during different times (time of a day, time of a year), on time of higher communications load, or on times of a disaster, such as during fire.

Upon obtaining information packets or any other form of messages from the nodes, whether in a direct or indirect manner, a controlling processor can assemble together data relating to different nodes and/or to different measurements on a certain node or nodes. On order to assemble the data the controlling processor may use relative and/or global positioning information carried by the messages. Data may be assembles also in a transmission node, and even in nodes wherein the node processor allows. Understanding this it may he appreciated that a controlling processor gains knowledge indicative of measurements performed on single nodes as well as on pluralities of nodes. Hence it is possible to state that the controlling processor gains knowledge and information indicative of measurements performed on sets of nodes, wherein each set includes one or more nodes. It is noted that the number of nodes in a set may even reach hundreds of thousands or millions of nodes.

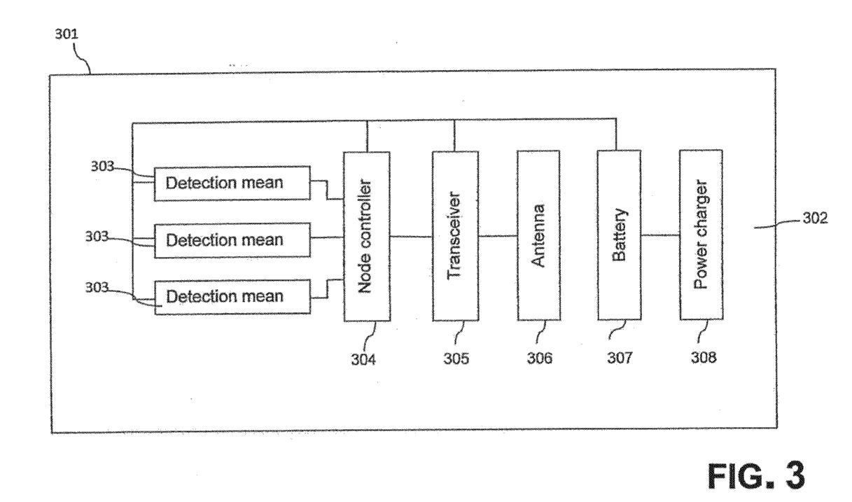

FIG. 3 is a block diagram representing a forest fire control node 301 in accordance with certain embodiments of the invention. It was previously explained, with reference to FIG. 1, that a node is comprised of at least a hanging unit, and one or more detection means. Accordingly, the illustrated node 301 includes a hanging unit 302, enclosing three detection means 303. In addition, the illustrated node includes also a node controller 304, a communications transceiver 305 coupled to an antenna 306. A battery 307 and a power charger 308 (e.g. a solar power charger) coupled thereto are configured to continuously provide power to the node and the elements comprising it.

It is stressed that this embodiment is only a non-limiting example of a node. For example, there is no requirement that a node should include three detection means, and the power charger is non mandatory as well, e.g., in a handheld node or in a mobile node installed in a car. Likewise, there may he a node without a transceiver: such a node is configured, for example, to transmit UV radiation having a predetermined intensity (e.g. at a predetermined timing), thus allowing other nodes to detect the UV radiation and process its characteristics in order to conclude and acquire information relating to the environment.

Furthermore, the detection means comprised in a node may be of any type required for detecting the environmental condition they are designed for. For example, there may be RF transceivers, ultraviolet (UV) generators and detectors, infrared (IR) generators and detectors, a Global Positioning System (GPS) receiver, accelerometers, pressure detectors, etc. Environmental parameters, information relating thereto may be detected by the system include, for example, environmental moisture and humidity, barometric pressure, thermal information, wind, smoke and others.

After deployment of a system in accordance with the invention, the nodes hanging on trees may need to stay operative for a long period, optionally throughout years. Understanding that the detection means as well as the transceiver (and possibly other components as well) require energy for their operation, a power source is required. The battery 307 is configured to serve as such a power source. However, knowing that non-rechargeable batteries have limited, relatively short life span, a rechargeable battery may be used, coupled to a charger.

One embodiment of a charger 308 is a solar power charger. However, such a charger must he exposed to direct sun light in order to gain solar energy while in the forest at least part of the area under the canopy is shadowed. According to the invention there is another energy resource, whose availability in the forest is normally higher compared to solar energy. This is kinetic energy. During most of the time branches of the trees are moving in the wind, and by harvesting the kinetic energy associated with the movement of branches it is possible to recharge the battery. The power charger 308 of FIG. 3 can hence be a kinetic recharger. Furthermore, by attaching the hanging unit to the tree in a way that allows it to move relative to the branch, may increase the kinetic energy available for harvesting.

In addition, during fire, there is an enormous source of energy in the forest; this is heat. Thermo-energy may be harvested then, while there are commercially available devices for the matter. One example is “ECT 310 Perpetuum™” by EnOcean™. Such a harvesting system may be optimized to operate under fire conditions, such as by using and configuring the system for best operation at temperatures and frequencies that carry most of the energy during fire.

Another optional charger is an electro-magnetic (EM) charger operated, e.g., by an airplane or a helicopter, flying above the forest and transmitting EM energy that charges the nodes. The advantage of using such a charger is by leaving a certain degree of control at the hands of the crew in charge of the forest.

According to an alternative embodiment, if applicable to the case, it is possible also have redundancy by installing more than one charger within a node, such as a combination of a kinetic charger, a thermo-energy charger and an EM charger, allowing the node to benefit many possible energy sources at the cost of size and mass.

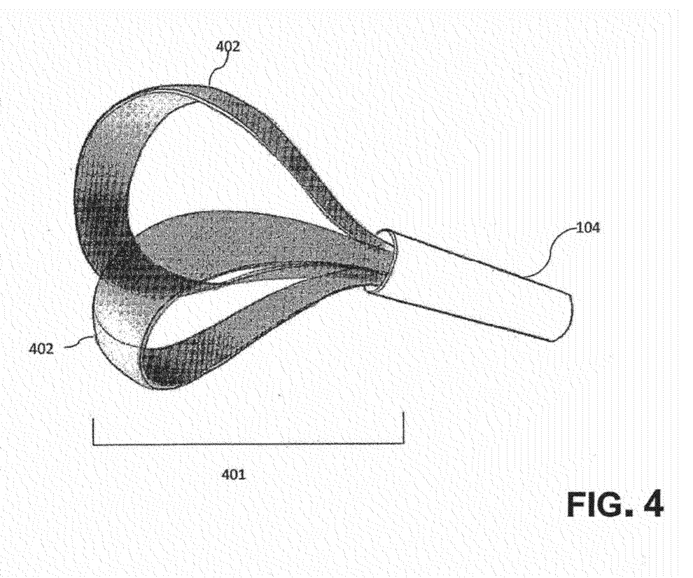

FIG. 4 schematically presents an example of a hanging mechanism 401, according to embodiments of the invention. In the illustrated mechanism there are strips 402 connected to a hanging unit 104. A strip 402 constitutes an “attaching element”. According to the invention, the attaching elements are configured to be attached to a branch or to branches of a tree, thereby hanging the hanging unit 104 on the branch.

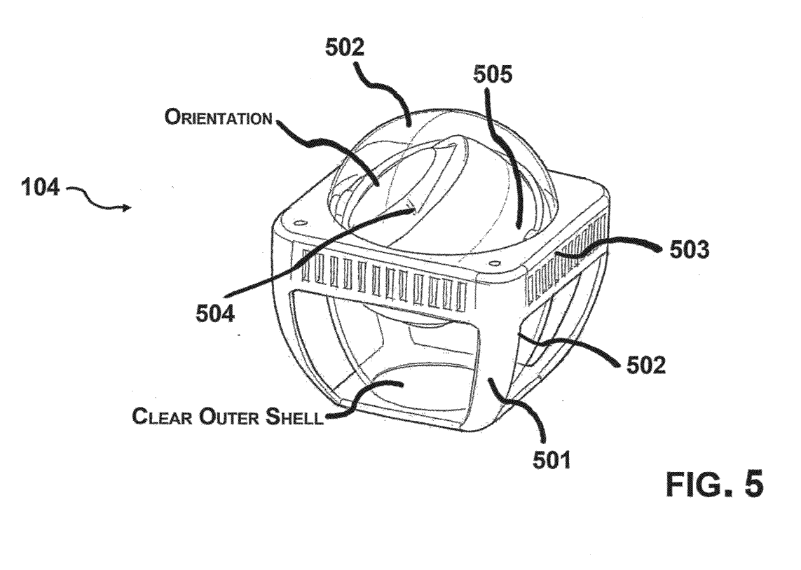

FIG. 5 is a schematic illustration of a hanging unit 104, in accordance with certain embodiments of the invention. It was previously explained, with reference to FIG. 1, that a node is comprised of at least a hanging unit 164, and one or more detection means. The hanging unit is configured to attach the other elements comprising the node to a tree, keeping those elements together and protecting them from environmental hazards, thus enabling their operation. Therefore the hanging unit comprises an outer enclosure 501, which according to the embodiment may be rigid in order to provide physical protection for the enclosed elements. In addition, it may be required to protect the other elements from environmental conditions such as extreme temperature (that is, temperature that is higher or lower than the working range of the other elements) and/or humidity. Therefore according to the present embodiment an isolating enclosure 502 also exists. Other embodiments may have a single enclosure replacing the outer 501 and the inner 502 enclosures and providing both rigidity and isolation. In yet other embodiments, the external enclosure may be elastic, instead of rigid, while elasticity may characterize also a single enclosure replacing the outer and inner enclosure.

Because some of the other elements require exposure to the outer environment in order to fully operate, the outer and/or inner enclosures may have perforations 503, allowing such exposure for the elements enclosed inside. For example, climate detections require such exposure, e.g., for humidity and wind measurements. In the embodiment illustrated in the figure the perforations are arranged around the perimeter of the hanging unit, however this is non-limiting and the perforations may be otherwise arranged in any way applicable to the ease.

Moreover, it may be appreciated that there may be detection and harvesting means that require maintaining certain orientation with reference, e.g., to the ground, in order to allow full operability. Such means are, for example, IR detector and sun light harvesting. In order to provide them with a working environment, the present embodiment constitute a gyroscope like body constituting an “orienting body” 504. The orienting body 504 is coupled to the inner enclosure 501 and possibly also to the outer enclosure 502. Via a connecting element 505, which in the present embodiment is a gyroscope pivot mechanism.

Further to learning about the orienting body, those versed in the art would appreciate that upon motion of the nagging unit, it is most probable that the orienting body will move inside, in order to maintain orientation. This “double motion”, of the hanging unit 104 and of the enclosed orienting body, will result in a relative motion of the orienting body compared to the inner enclosure. This relative motion has kinetic energy, that can be further harvested by the charger 308, in those embodiment using a kinetic power charger.

Further to explaining the structure of a hanging unit 104 according to certain embodiments of the invention, attention is drawn now to the detection means enclosed therewith. It is appreciated by those versed in the art that many such detection means are commercially available today and hence they can be used as applicable.

Detection means 303 are configured to measure physical characteristics of the environment, such as, temperature; humidity; wind intensity and direction; presence of smoke; location of the node; speed and acceleration; vibrations; changes in height; change in detector location; the intensity of radiation required for reaching the closest nodes; intensity of radiation required tor reaching the next close nodes; reflection from the forest area received at the node in different frequencies; antenna impedance; temperature of objects at different distances from the node; Electro-Magnetic (EM) characteristics of the medium, measured by the node or by a series of nearby nodes; light spectrum sensor; infrared (IR) sensor; radio frequency (RF) sensor, and others.

Measurements considered critical, or at least highly important according to the embodiment, may possibly be performed by more than one detection mean. This way, there might fee more than one smoke detection means. For example, a regular optical detector, reflected beam detector, ionization, laser and others. The detector may be protected from, weather conditions, such as rain, fog and others.

Likewise, there may also be more than one temperature detection means, such as a thermocouple; a semiconductor temperature sensor, an infrared (IR) sensor, an IR camera; or others. When using an IR camera as a temperature detection mean, if is possible to aim the camera towards a certain area (e.g. downwards). Alternatively, the camera can be built around the node, to cover the largest possible angle while measuring temperatures around the node.

In addition to using different detection means for detecting and measuring a single environmental characteristic, if is possible to use a single mean, operating it in different ways. One such example is a Global Positioning System (GPS) device connected to a GPS antenna, a configuration that is substantially similar to a modern cellular telephone.

According to one embodiment, each node is configured to detect its respective position, using the GPS device enclosed therewith. Alternatively, the location obtained from the GPS device may be fine-tuned using information obtained from the GPS devices of neighboring nodes, with or without relative position information extracted using wireless communication between nodes. According to another alternative, the position of each node may be calculated, using a relative-position calculation between nodes, while one or more of the nodes serves as a pivot haying a known position, obtained, for example, from the controlling processor or from another controller external to the node.

Acceleration detection means may also include one or more detection means, such as piezoelectric, IR or others.

If was mentioned before, e.g., with reference to FIG. 3, that according t many embodiments a node has a node-processor 304 associated therewith. The node processor may decide when reports should he sent to neighboring nodes and/or to the controlling processor 106. The node processor may also decide whether to forward a message obtained from another node, or whether to block this message from further propagating. Such decisions are based on a set of conditions that may be predetermined (e.g., during node configuration) or may be obtained during node's operation, e.g., via communication obtained from another controller such as the controlling processor or any other processor configured for this task such as a transmission node's controller. Alternatively, the set if conditions may change and evolve in response to measurements performed by the node or measurements performed by other nodes whose results are propagated to reach the present node. Yet alternatively set of conditions can be altered in accordance with the status of the battery.

In addition, the node controller may decide when and what detections and measurements should be performed, and by what detection means. For example, regularly only one temperature sensor may operate, possibly the one with the lowest energy consumption. If the present node, or any other near-by nodes measure and detect rise in temperature, the node controller may decide to operate additional temperature sensors, such as an IR camera, e.g., in order to improve the accuracy of the measurements. Additionally and/of alternatively detection means may be operated or turned of in response to the battery's status, in response to obtaining external commands, periodically, in response to an alert level, etc.

In the market there are commercially available processors that may be used as node processors. One example is Max II™ from Altera™.

Further to understanding what is a node and how it may operate, and before turning to discuss how the system can be deployed it is important to remember FIG. 2, with reference thereto the importance of the distances between nodes has been discussed. Considering that the distance between nodes should not exceed a certain distance, it may be understood that a medium sized forest require deployment of many nodes to achieve coverage. Discussing deployment, therefore, it is appreciated that ground deployment (personnel hanging the nodes) is applicable mainly for small or even very forests and a mass deployment method must be developed.

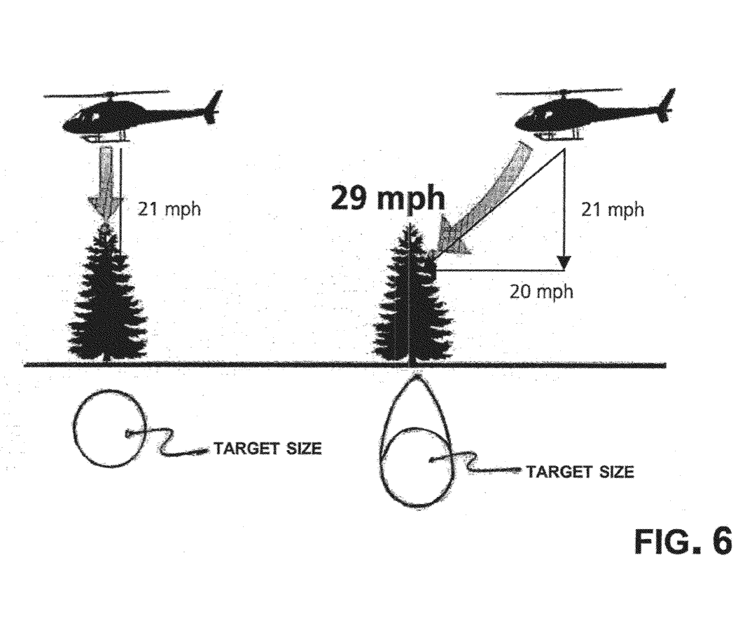

Such a mass aerial deployment method, according to one embodiment of the invention, is presented by FIG. 6. A helicopter or an airplane may scatter nodes from above the forest. It is appreciated that the falling node-devices may hit the canopy directly from above, or it may his it in an angular manner. The figure specifies several values for example, representing the impact a device may have from, aerial deployment.

It is appreciated that a node falling from an airplane or a helicopter should be decelerated in order to allow its safe anchoring on the forest canopy. A deceleration element coupled to the hanging unit may serve for this matter, such as a small parachute opened automatically at a certain height or a certain short time interval after been thrown from the airplane or helicopter.

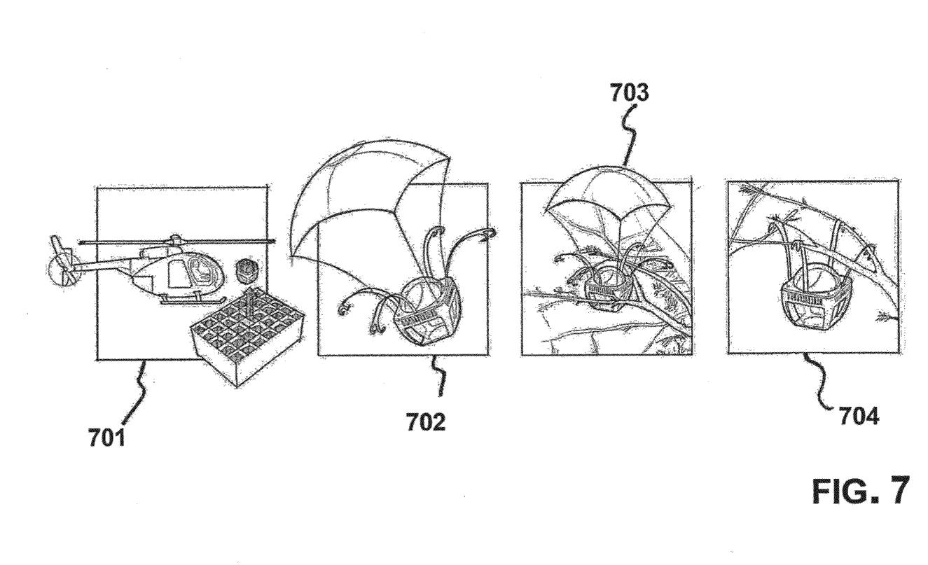

FIG. 7 schematically illustrates the stages of aerial-deploying a node device according to one embodiment of the invention. 701 illustrates one way for packaging the nodes prior to scattering them by the airplane. Packaging should allow automatic pulling out of a single node each time, by an arm or any other form of a scattering device installed on the airplane or helicopter.

Although not shown in the figure, it should be appreciated that prior to scattering the devices it is possible to calibrate them, an operation that may be performed, e.g., by the scattering device. For example, by knowing the speed of the airplane or helicopter, the exact position thereof while throwing a node device, and the height above the canopy at time of throwing, the position where the device would meet the canopy can be rather accurately estimated prior to throwing (see, for example, FIG. 6). This position can be transferred to the node device, to be stored in a memory device therein, and then it may be later used for calculations. Moreover, the estimated position may be listed, e.g., together with the device serial number, and stored at the control processor, for example, where it can later be used while assembling and later analyzing data.

After throwing a device (see 702), a decelerating mechanism is operated, such as by opening a parachute. Also during falling, the attaching elements comprising a hanging mechanism, are prepared for attaching the hanging unit to branches, upon meeting the canopy (703). When attached (704) the hanging unit is anchored to one or more branches of the tree, moving in the wind therewith. It should be appreciated that the attachment is a long term attachment and the hanging unit may stay attached to the branch for years.

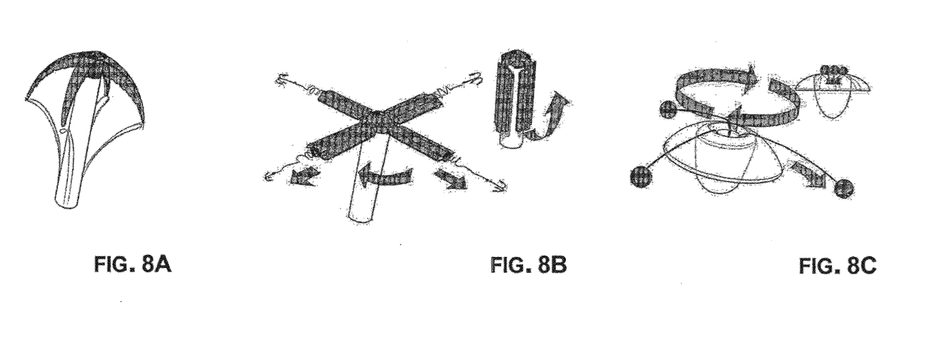

In 704, FIG. 7 it appears that after attachment the parachute is disconnected from the hanging unit. This is non limiting and other embodiments, wherein the parachute stays connected are also allowed. Similarly, the hanging mechanism illustrated in FIG. 7 is non-limiting as well and alternatives may be applicable, e.g., such as the mechanism previously illustrated, in FIG. 4 and such as the mechanisms illustrated in FIGS. 8A, 8B and 8C that schematically illustrate hanging mechanisms according to embodiments of the invention.

After deployment the detection means enclosed with the nodes start detecting physical characteristics of their environment, while the nodes start passing messages to other nodes, to transmission nodes, and to a controlling processor.

It was previously explained that a controlling processor may assemble information and gain knowledge, wherein the measurements performed on sets of one or more nodes is being indicative thereof. It should be appreciated that by analyzing this knowledge with or without reference to other knowledge accessible to the controlling processor (hereinafter the other knowledge constitutes “external knowledge” or “external information”), the controlling processor may monitor the forest for early detection of fire, and upon detecting such fire the controlling processor may perform firefighting efforts management. Examples of external knowledge may include knowledge relating to availability of fire retardant, availability of firefighting forces including firefighting engines, availability of water, cartographical maps, etc.

For example, nodes may detect and measure temperature therearound. Then, the controlling processor collecting the temperature information from a set of nodes in a certain area, may gain a three dimensional (3D) map of temperature at the nodes vicinity. Similarly, by collecting information relating to radio frequency (RF) absorption from couples of nodes, a map presenting flora moisture at the nodes vicinity may be created.

During fire, the controlling processor continues obtaining messages from nodes, hence it continues gaining knowledge indicative of measurements performed thereby. Moreover, because emergency forces enter the zone of fire, while they may carry mobile nodes therewith, the controlling processor may gain knowledge that would have been unavailable thereto when forces are absent, mainly when there is no fire. Accordingly, the controlling processor continues to be update during all times.

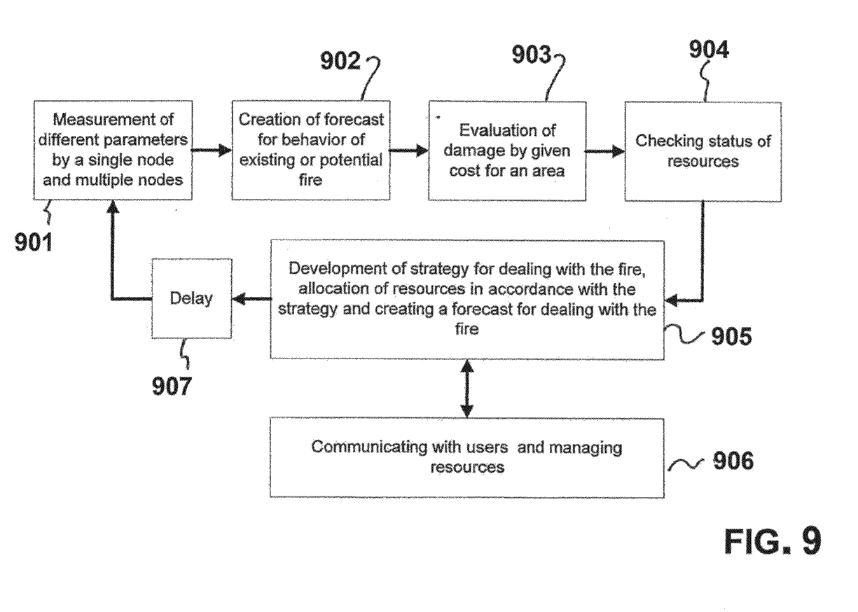

FIG. 9 is a flowchart illustrating the main operations performed by a controlling processor, according to certain embodiments of the invention. Further to obtaining measurements of different parameters by single and multiple nodes (901), and gaining knowledge corresponding to the measurements, forecast of behavior of existing or potential file is created on 902. For creating the forecast the controlling processor may consult external knowledge such as topography, meteorological observations etc.

According to certain embodiments, the controlling processor maintains a map of the forest gone, wherein every area in this zone obtains a score reflecting the potential damages that would occur by fire in this zone. For example, in a certain first zone there are only trees, in a second zone there is a village nearby, while in a third zone there is a recreational resort. In this example, the basic score of the first zone is lowest, the score of the second zone is highest while the score of the third zone is in between, in a certain day a conference takes place at the resort hence bringing thousands of people thereto. The score of human life is highest amongst all and therefore at the days of the conference the score of the resort, i.e., the third zone, becomes highest. That is, scoring is non constant and variations may occur. The controlling processor may obtain updated scores as external knowledge. Alternatively, by obtaining information relating to the zone the controlling processor may calculate sc0res. Accordingly, on 903, the controlling processor can evaluate the damages that will be done by fire in a certain zone.

On 904 the controlling processor is configured to check the status, i.e., availability of resources. Examples are fire retardants, firefighting engines in vicinity, firefighting aircrafts available, accessible water pipes and others. Based on the information obtained at 901, 902, 903 and 904 the controlling processor may develop, on 905, a strategy for dealing with the fire. On 906 strategy is propagated to users of the system. For example, a firefighter in the field may obtain an advise whether to take one route or another while entering the fire zone and/or while escaping therefrom. He may be advised, for example, that the high fire in front of him is only several centimeters thick, while what appears to be a low fire area occupies many tens of meters. The firefighter may decide to follow the systems's advises or not, while he may provide feedback represented by the returning arrow. Others the strategy may be propagated to are commanders of the rescue and emergency forces, citizen living in vicinity to the fire, rescue forces headquarters and any other entity who may require information.

When there is no fire in the forest the method of FIG. 9 may be used for calculating the risk that fire will start at different positions in the fire, and accordingly the strategy may provide advice for managing resources so as to minimize the risk. Generally, it should be appreciated that valuation of strategy is a time-aligned backtracking optimization algorithm. The algorithm proposes allocation of resources, computes a forecast given that allocation, computes the cost (or score) in accordance with the forecast and finds a minimum of the cost. The best suggested strategy, in accordance with the algorithm, is the strategy whose cost is minimal amongst all costs of other proposed strategies.

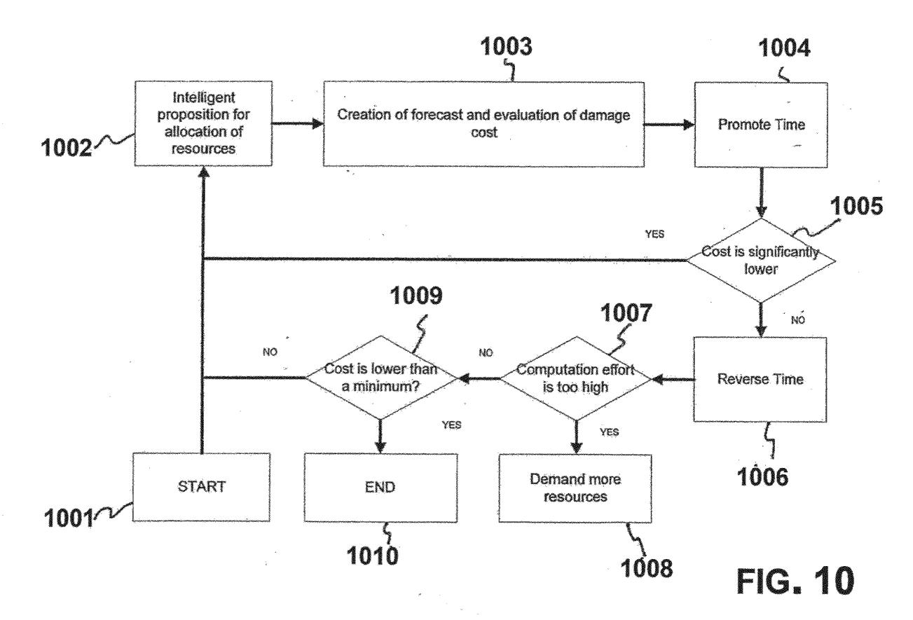

FIG. 10 is a flowchart demonstrating in detail the operations performed by a controlling processor while developing firefighting strategy, according to certain embodiments of the invention. Upon start (1001) the algorithm; proposed allocation of resources (see 1002). Based on this proposition, on 1003, a forecast is created, evaluating the cost of damages that are expected in accordance with this forecast (damages and cost were previously explained with reference to 903, FIG. 9). The algorithm performs kind of simulation, therefore on 1004 the “simulation” is advanced forward and on 1005 the expected results are checked, in terms of cost. A successful strategy is expected to reduce and minimize cost, hence, if the cost is significantly lower than expected cost prior to applying the strategy, the process reverts to 1002, in order to check other propositions and ver item is better. If cost is not lower (on 1005), the algorithm goes back in time (1066) and then, on 1007, checks the computation efforts invested, such as how many iterations has been performed so far, computation time invested, etc. High efforts mean that there are not enough resources, and increased resources are required (1008). If, on the other hand, 1007 indicates that the computation, efforts invested are not too high, 1009 checks if a certain minimal cost has been reached, thus indicating that the fire is under control (reaching the end on 1010). Alternatively, the algorithm continues to suggest another allocation, of resources on 1002.

It will also be understood that the system according to the invention or part thereof may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

1. A system for forest fire control, comprising a plurality of forest fire control nodes, each node comprising:
one or more detection means of an environmental condition;
at least one communication transceiver for sending and receiving data indicative of a sensed environmental condition; and
at least one hanging unit configured for hanging the node on a tree.

2. The system of claim 1, comprising a central unit configured to:
receive data indicative of a sensed environmental condition from at least two of the plurality of forest fire control nodes;
analyze said data to determine a forest fire status;
provide output relating to the forest fire status.

3. The system of claim 1, comprising
a central unit configured to receive data indicative of a sensed environmental condition over a period of time during a forest fire from at least one of the plurality of forest fire control nodes; and
a database for storing said received data; and
a processor configured to analyze said receive data to produce a prediction of future fire behavior.

4. The system of claim 3, wherein the processor is configured to provide a response strategy to a forest fire based on the prediction.

5. The system of claim 4, comprising a resource tracker for providing information on resource availability and wherein the processor is configured to provide the response strategy to a forest fire based on resource availability.

6. The system of claim 5, wherein the processor is configured to provide a response strategy to a forest fire using an optimization algorithm.

7. The system of claim 5, wherein the processor is configured to provide a response strategy to a forest fire using a time-aligned backtracking algorithm.

8. The system of claim 5, wherein the processor is configured to provide a response strategy to a forest fire using an algorithm designed to minimize the area expected to be covered by the fire within a predetermined period of time.

9. The system of claim 5, comprising a database containing data indicative of high priority areas within the forest area, and wherein the processor is configured to provide a response strategy to a forest fire using an algorithm designed to minimize damage to high priority areas.

10. The system of claim 5, wherein the processor is configured to provide a response strategy to a forest fire using an algorithm designed to minimize costs of operation.

11. The system of claim 5, wherein the processor is configured to provide a response strategy to a forest fire using an algorithm designed to minimize hazard to firefighters.

12. The system of claim 5, wherein the processor is configured to provide a response strategy to a forest fire using an algorithm designed to strike a balance between at least two of:
minimizing the area expected to be covered by the fire within a predetermined period of time;
minimizing damage to high priority areas;
minimizing costs of operation; and
minimizing hazard to firefighters.

13. The system of claim 1, wherein the nodes have a dormant state and an active state and are configured to switch from a dormant state to an active state at preset timing.

14. The system of claim 1, comprising stationary nodes and mobile nodes, wherein the mobile nodes and stationary nodes are configured to communicate between them.

15. A forest fire control node, comprising:
at least one sensor of an environmental condition;
at least one communication transceiver for sending and receiving data indicative of a sensed environmental condition; and
at least one hanging unit configured for hanging the node on a tree.

16. The forest fire control node of claim 15, comprising a kinetic charging mechanism.

17. The forest fire control node of claim 15, comprising a processor configured to
receive from the sensor local data Indicative of a local environmental condition;
receive from the communication transceiver remote data indicative of a remote sensed environmental condition sensed by at least one remote fire control node;
analyze said local data and remote data; and
issue a response based on said analysis.

18. The forest fire control node of claim 17, wherein the response comprises providing an instruction to the at least one remote fire control node to regulate a sensing condition of the remote fire control node.

19. A method for forest, fire control comprising:
deploying a plurality of stationary forest fire control nodes over a forest area, each node comprising:
at least one sensor of an environmental condition;
at least one communication transceiver for sending and receiving data indicative of a sensed environmental condition; and
at least one hanging unit configured for hanging the node on a tree.

20. The method of claim 19, wherein the plurality of forest fire control nodes are deployed such that each forest fire control node is within communication distance from at least one other forest fire control node.
